(19) United States
(12) Patent Application Publication
(10) Pub. No.: US 2021/0182480 A1
(43) Pub. Date: Jun. 17, 2021

(54) PARSER FOR ARBITRARY TEXT BASED LOGS

(71) Applicant: SAP SE, Walldorf (DE)

(72) Inventor: Susan Marie Thomas, Karlsruhe (DE)

(21) Appl. No.: 16/714,614

(22) Filed: Dec. 13, 2019

(51) Int. Cl. G06F 40/205; G06F 40/137

(52) U.S. Cl. CPC G06F 40/205; G06F 40/137

(57) ABSTRACT

In some embodiments, there is provided a parser comprising at least one data processor; and at least one memory storing instructions which, when executed by the at least one data processor, result in operations comprising: receiving a line of text to be parsed; and processing, based on a configuration for the parser, the line of text into parsed text by at least: detecting one or more brackets and one or more separators in the text, determining a hierarchy for the text based on one or more parts, the one or more parts determined from the one or more brackets and one or more separators, and parsing, based on the hierarchy, the text to form the parsed text. Related systems and articles of manufacture are also provided.

### TECHNICAL FIELD

The subject matter described herein relates generally to parsing text.

### BACKGROUND

Many applications write to logs for a variety of reasons including, for example, error monitoring, security monitoring, performance monitoring, and/or for other reasons. But finding, understanding, and parsing the lines of a log that are relevant to a specific purpose can be a challenging task for at least the reason that although there are some standards for writing to logs, they are not widely used or are not used according to their specification

### SUMMARY

Systems, methods, and articles of manufacture, including computer program products, are provided for parsing text.

In some embodiments, there is provided a parser comprising at least one data processor; and at least one memory storing instructions which, when executed by the at least one data processor, result in operations comprising: receiving a line of text to be parsed; and processing, based on a configuration for the parser, the line of text into parsed text by at least: detecting one or more brackets and one or more separators in the text, determining a hierarchy for the text based on one or more parts, the one or more parts determined from the one or more brackets and one or more separators, and parsing, based on the hierarchy, the text to form the parsed text.

In some variations, one or more of the features disclosed herein including the following features can optionally be included in any feasible combination. The parser may further generate, based on the determined hierarchy, a user interface view including the hierarchy and/or parsed text. The parser may store the parsed text to a database logging a plurality of text parsed by the parser. The at least one separator to be detected may be a key value separator, and the key value separator may separate at least one key and a value. The parser may include a machine learning module which when executed detects the pair of brackets, the key value separator, and the at least one key. The detecting may include detecting one or more pairs of brackets by processing the received text from left to right and ignoring a bracket if it does not include a matching bracket. A level may be assigned to each of the detected pairs of brackets, the assigned level used to determine a hierarchy.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a machine learning based plug-in for accessing a cloud-based analytics engine, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a parser, in accordance with some example embodiments;

FIG. 2A depicts an example of a process for parsing, in accordance with some example embodiments;

FIG. 2B depicts an example of punctuation detection, in accordance with some example embodiments;

FIG. 2C depicts an example of the bracket matching, in accordance with some example embodiments;

FIG. 2D depicts an example of the levels assigned based on the matched brackets, in accordance with some example embodiments;

FIG. 2E depicts an example of the text divided into parts at level 0, in accordance with some example embodiments;

FIG. 2F depicts an example of keys and values for the parts of the line of text, in accordance with some example embodiments;

FIG. 2G depicts an example of the naming of nested keys, in accordance with some example embodiments;

FIG. 3 depicts an example of a hierarchical structure generated based on the parser, in accordance with some example embodiments; and

FIG. 4 depicts a block diagram illustrating a computing system, in accordance with some example embodiments.

When practical, similar reference numbers denote similar structures, features, or elements.

### DETAILED DESCRIPTION

In some embodiments, there may be provided a configurable parser. The configurable parser may parse an arbitrary text-based log line into its components, such as key value pairs. The key-value pair may include a key, a key-value separator, and a value. For example, “severity=INFO” is a key-value pair with the key of “severity”, the key-value separator of “=”, and the value of “INFO”. The component types created by the parser are: key-value pair, key's value (a sub-component of key-value pair), empty key (a key with no value), leaf, and the like.

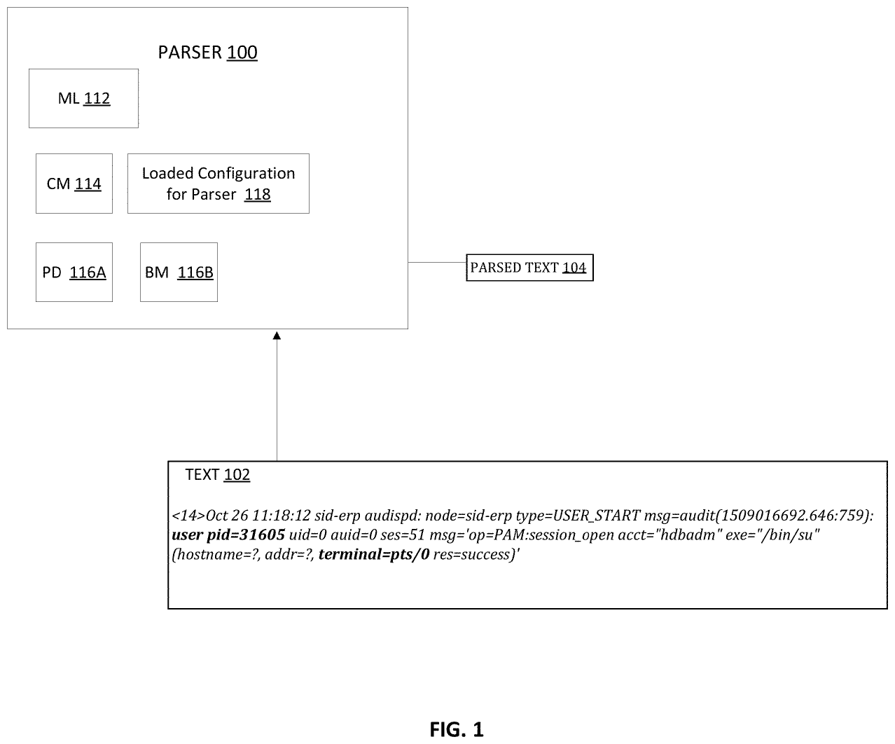

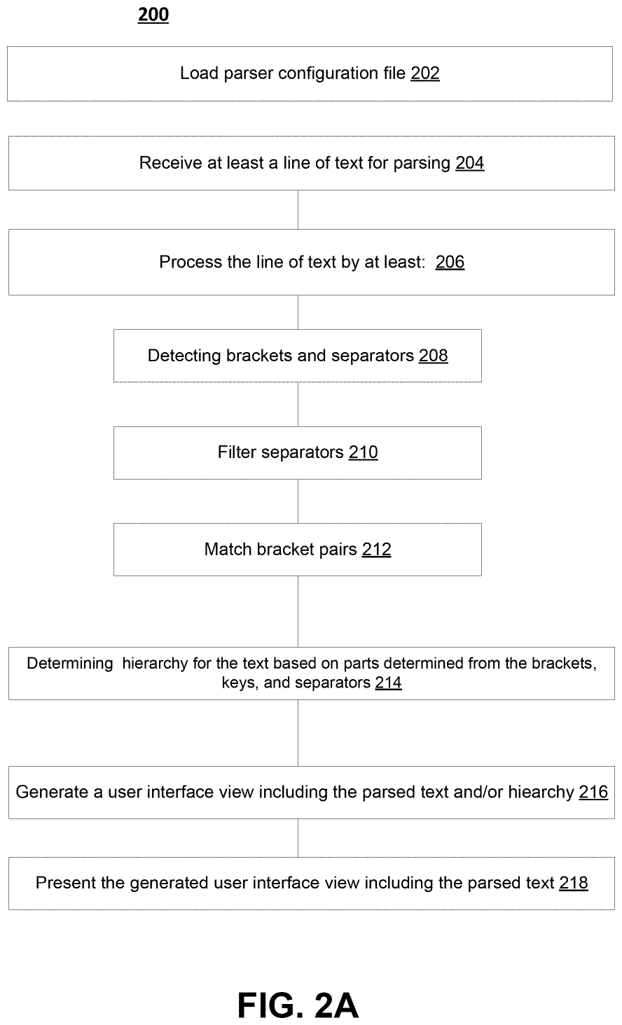

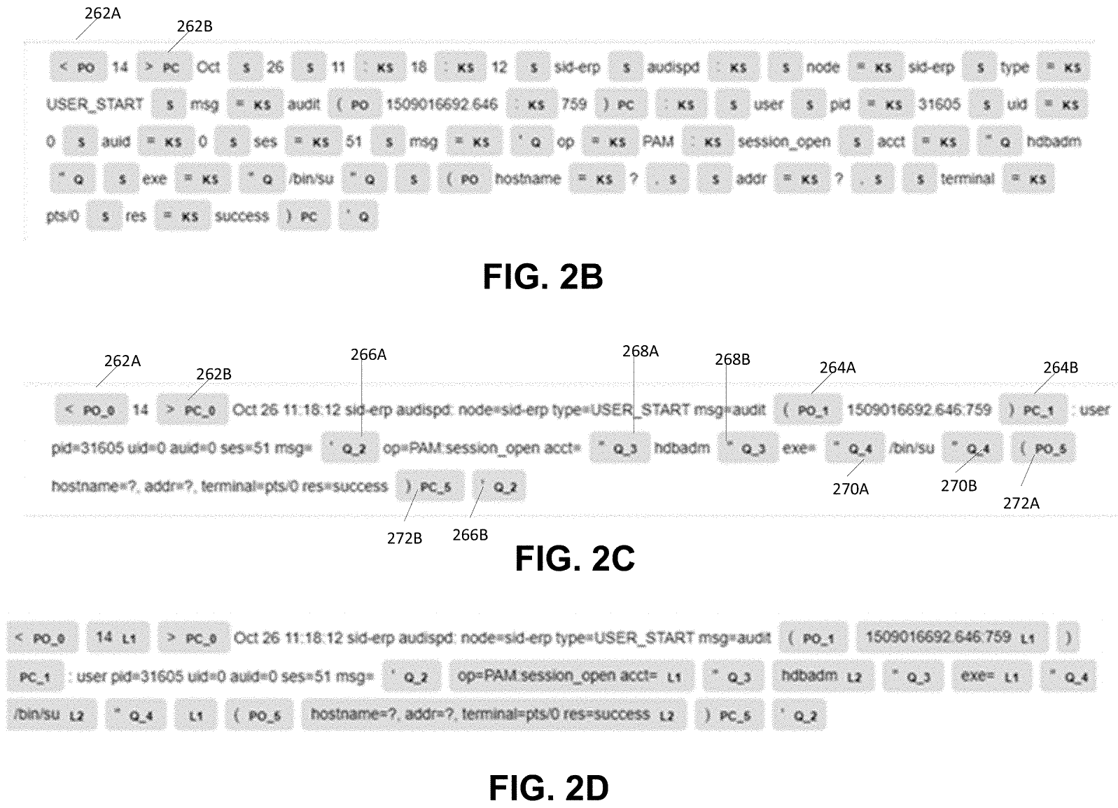

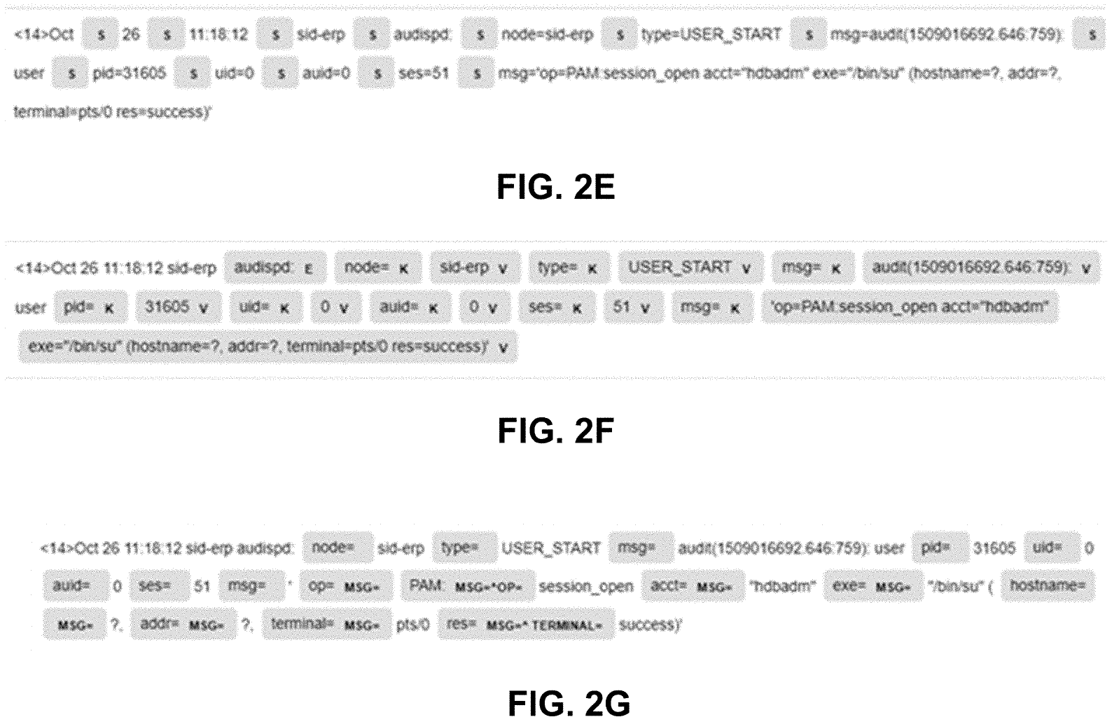

FIG. 1 depicts an example of a configurable parser 100, in accordance with some example embodiments. The configurable parser 100 (also referred to herein as parser) may include at least one processor and at least one memory including program code which when executed cause one or more of the operations disclosed herein with respect to the parser. The parser 100 may parse at least a line of text 102 into parsed text 104. For example, the line of text 102 may be a stream of text from a blog, a chat session, an error log, and/or the like. There may be little or no structure or formatting in the line of text 102, but the parser 100 may be configured to parse out text from the line of text to output parsed text 104, such as a key value pair in the text or other type of text in the line of text 102. In the example of FIG. 2, the parser 100 may load a configuration file 118 for the parser. The parser may also include a punctuation detector (PD) 116A, a bracket matcher (BM) 116B, a clustering module (CM) 114 for compressing and/or grouping parsed text, and a machine learning (ML) module 112.

FIG. 2A depicts an example of a parsing process 200, in accordance with some example embodiments. The description of process 200 also refers to FIG. 1.

At 202, the parser 100 may load a configuration, such as a configuration file 118, to configure the parser. The configuration customizes what the parser is supposed to detect, such as the types of punctuation strings being detected by the parser. To illustrate further, the configuration file may define what constitutes, a bracket, a separator, a structured only separator, a key value separator, and the like. The configuration file 118 may be customizable by a user. An example of a configuration file is shown at Table 3 below. Although the example of Table 1 shows the configuration file as program code, the configuration 118 may be in the form of data as well.

At 204, the parser 100 may receive (e.g., fetch, obtain, and the like) a line of text. For example, the parser may receive a line of text, such as text 102, to be parsed.

At 206, the parser may process the line of text 120 to detect, at 208, elements such as brackets, separators, key-value separators, structured-only separators, and other punctuations or symbols that are configured in the configuration file 118.

To detect the punctuation(s) that determines the structure of the line of text (208), the parser 100 may, as noted, load the configuration file 118 that defines for example which punctuations are to be detected. Punctuations function to separate components, separate a key from its value, or bracket a component. Separators may be of two types. Those that are always used and those that are ambiguous because they may often be used for purposes other than separation. The latter are called structured-only separators and must meet certain conditions before they are used as separators. If they do not meet these conditions (which may be defined in the configuration file 118 or in other ways), the punctuations may be ignored by the parser. Brackets may also be of two types, such as quotes and parentheses. The difference is that quotes use the same string to begin and end the bracketing, while the parentheses use one string to begin and a different one to end the bracketing. For example, the parser may define (based on the configuration file 118) the parentheses as a pair of one or more of the following: { }, [ ], ( ) and < >. Quotes might be the single and double quotes. In some embodiments, a classifier regex may be generated for all the punctuation being detected. And, the classifier regex is used to match, find, and classify all matching punctuation strings in the text 102.

In some embodiments, the parser 100 may implement a bracket processing algorithm, at 208, that includes the following. For each bracket type, the parser may process from the beginning of the line 102 line to the end of line 102. Given that the bracket type is a parenthesis for example, if the parser finds an opening parenthesis the parser should find a matching closing parenthesis in the line of text. In some embodiments, if a closing parenthesis is encountered, but there is no opening parenthesis before it, the parser 100 ignores the closing parenthesis as there is no opening bracket to match it with. In some embodiments, if the parser detects an opening bracket and then a closing bracket but the pair violates a bracket match condition, the brackets may be ignored and marked as conflicting because the bracket pair conflict with the bracket structure created by previously processed bracket types. In some embodiments, if the parser encounters an opening bracket but there is no closing bracket before the end of line 102, the parser ignores the opening bracket because there is no closing bracket to match. In some embodiments, if a potential pair of brackets are found, the pair can only be considered a match if a bracket matching condition is satisfied (which may be defined in the configuration file 118). For example, the bracket matching condition may specify that the pair of brackets need to be at the same level (e.g., depth in a hierarchy), and any other brackets between that pair may be considered to be at the same level as the pair or at a greater or higher level in the hierarchy.

As noted, the parser 100 may detect, at 208, separators in the line of text 102. The separators may include a key value separator that separates a key and a value. For example, the text, “severity=INFO”, is a key value pair with the key of “severity”, the key value separator of “=”, and the value of “INFO.” In some embodiments, the parser may include a user definable (per the configuration file 118) list of separators in program code. For example, configuration file may take the form of program code (as shown in Table 3, for example), and the program code may be as follows: keyValueSeparatorList=tuple(r‘=:’).

At 208, the parser 100 may detect other types of separators as well to separate components in a list of values. For example, a comma (,) or semi-colon (;) may be used to separate values in a list. At 208, the parser configuration may also detect structured-only separator, such as the hash (#) or caret (\hat{ }) to separate structural fields.

At 210, the parser 100 may filter detected punctuations to remove any punctuations that are internal syntactic punctuations, such as punctuations within MAC addresses and URL. The filtering may include presenting an element, such as a punctuation, at a user interface to allow a user to confirm that the element should be ignored for purposes of generating a hierarchy for the text 102 being parsed.

FIG. 2B depicts an example of the parser's punctuation detection. The labels “PO” for parenthesis open, “PC” for parenthesis close, “Q” for quote, “S” for separator, and “KS” for separator between key and its value have been added to illustrate the detection. For example, the PO 262A and PC 262B are detected.

At 212, the parser 100 may match bracket pairs. For example, if an opening bracket, such as a “(”, is detected, the closing bracket “)” is also mapped to that opening bracket. FIG. 2C depicts an example of the bracket matching. Brackets may be matched, by the parser, from left to right in a line of text or in an order defined by the configuration file 118. As noted, the matching may take into account the bracket matching condition(s). In the example of FIG. 2C, PO 262A and PC 262B are matched; PO 264A is matched to PC 264B; Q 266A is matched with Q 266B; Q 268A is matched with Q 266B; Q 268A is matched with Q 266B; Q 270A is matched with Q 270B; and PO 272A is matched with 272B.

At 214, the parser 100 may determine a hierarchy for the text 102, and this hierarchy may be determined based on the parts determined from on the detected brackets, keys, and/or separators. For example, the levels of the hierarchy may be determined based on the matched brackets. FIG. 2D depicts an example of the levels assigned based on the matched brackets. In the example of FIG. 2D, content not grayed out is assigned level 0, while the lower levels of the hierarchy are labeled L1 (for level 1), L2 (for level 2), and so forth. In the example of FIG. 2D, text not contained within brackets is considered level 0 and thus not grayed out, so it would be the highest level in the hiearchy. Next, the parser 100 may generate a hierarchy for the text 102. For example, the structure, such as the hierarchy, for the text may be generated, based on the detected punctuation types and matched brackets. This structure may also include determining labels for the parts of the line of text and the hierarchy of the parts.

To determine the hierarchy at 214, the line may be divided by the parser 110 into parts at the bracket-level. Initially, the whole line is treated like a part and the current bracket level is zero. Next, sub-parts of the current part are created by dividing at the highest priority separator type at the current level. If there are no separators, the parser divides the line at the current part into parts at the brackets at the current level. If there are also no brackets, the part is a leaf and is classified as a leaf. The parser may also detect the types (e.g., labels) of new parts as they are created. These part types may include key-value, key's value, empty key, leaf, and the like. The parser may also detect syntactic types of leaves, such as IP address or hostname.

FIG. 2E depicts an example of the text divided into parts at level 0. The split may be limited to one separator type, a type that is present, is at the required level, and has the highest priority. Each stretch of content between the separators that meet these conditions may become a new part to process. In this example, the split happens on spaces since there are no higher priority separators at level 0.

FIG. 2F depicts an example of keys and values for the parts of the line of text, in accordance with some example embodiments. In the example of FIG. 2F, since each part contains a key-value separator following a word, the word is interpreted as a key. The rest of the part is its value. In the example of FIG. 2F, K labels the key; its key-value separator, V, labels the value of key, and E labels an empty key. FIG. 2G depicts an example of the labeling (e.g., naming) of nested keys. Keys that are inside the values of other keys can be named to reflect this nesting. FIG. 2G also depicts the parents of nested keys. In this example, multiple keys are be separated by a caret. For example, the key “PAM:” is nested inside the key “op=”, which is nested in the “second msg=key”.

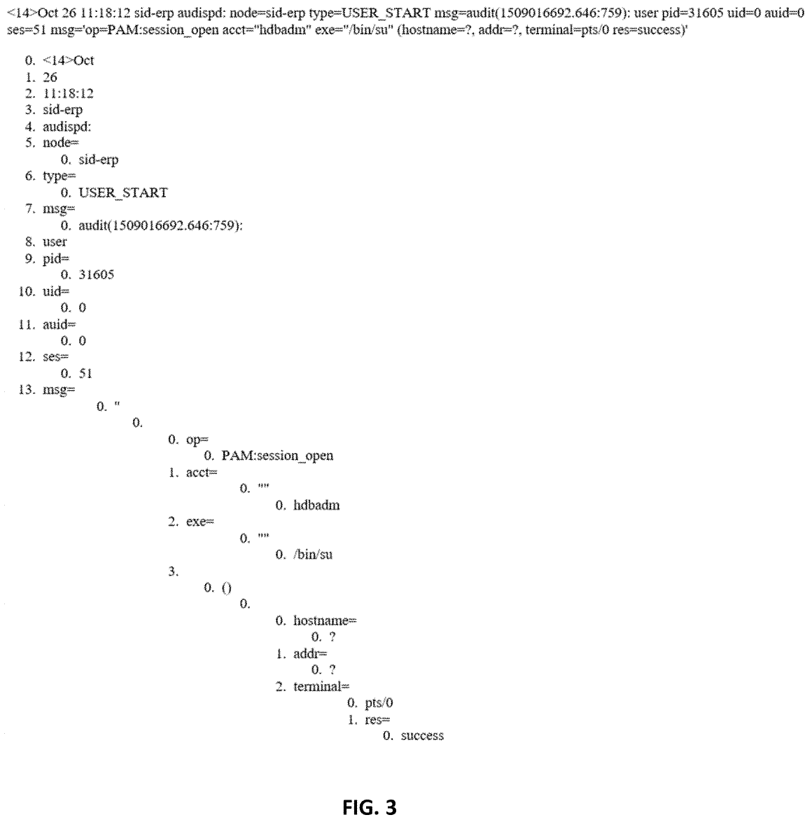

At 216, the parser may generate a user interface view including a portion of the parsed text 104 and/or the hierarchy generated at 214. This user interface view including parsed text may be presented on a display of a computer, a smart phone, or other type of processor. Alternatively, or additionally, the parser 100 may include parsing logic to form a hierarchy. This hierarchy may graphically show the structure of parsed text. An example of a hierarchy is shown at FIG. 3. Alternatively or additionally, the parser may perform other task on the parsed texts. These other tasks include, for example, clustering of lines to an event type, clustering of related event types (e.g., events from the same producer of the text), detection of event types, and/or detection of an error in a line of the log (e.g., a log line having mismatched brackets, missing separators, etc.). For example, the clustering module (CM) 114 may compress and/or may group the parsed text to provide a quick overview of a log file. The clustering module may also group to enable finding events relevant to a purpose and/or evaluation of specific events from open source or third party software logs.

In some embodiments, the parsed text 104 may be stored to a database or a log. For example, the parsed text may be stored to a database that monitors parsed text being logged. This storage to a database may be in addition to, or as an alternative to, the generating of the user interface and presenting of the user interface at 216 and 218. Moreover, once the text is parsed, it can be identified as to what the text represents (e.g., based on the labels associated with the parsed text), so the parsed text may be stored in an appropriate field of a database, for example.

In some embodiments, ML 112 may be used at 206 to improve the detection of the punctuations. Referring again to FIG. 1, the configurable parser 100 may also include machine learning (ML) 112. The ML 112 may be trained to perform one or more of the aspects depicted at FIG. 2A. For example, the ML 112 may be trained to detect brackets (208), separators (210), and/or keys (212). To illustrate further, the ML classifier may be trained to classify certain strings to a type. And, the parsing may identify punctuations, such as brackets, separators, and the like, and the labels used to identify these punctuations may be used to train the ML 112 to detect the punctuations.

The parser 100 may readily detect some formats, such as Common Event Format (CEF) and JAVA Object Script Notation (JSON). These formats may be handled by the configurable parser as so-called “special” cases, so the configurable parser can detect these specific formats and then parse in accordance with the specifications for each of these specific formats.

An advantage of the configurable parser is that it is configurable for arbitrary text based formats, so the configurable parser is not specific to a format. Another advantage is that the configurable parser may include or operate with machine learning. Yet another advantage is the ability to parse lines that contain errors that might stump a typical parser. For example, the configurable parser may correctly find all the key value pairs in the line depicted at Table 1 despite the missing comma after ipAddress=1.1.1.1.

TABLE 1
“time stamp” = 2019-01-22T12.21.13.013, place=ulm, ipAddress=1.1.1.1
severity=INFO, account=ids

Some software logs are written in an ad hoc format usually with one event per log line. The line format may be free text with embedded variables, a list of key value pairs, or the log line format may be structured (e.g., a list of components separated by a certain character like a semi-colon or hash). The format may be nested (e.g., as in the JSON format) or may be any arbitrary combination of formats, such as free text with embedded key value lists. Even if a standard format is used, for a log, the developer may embellish the format with additions or alter the format by omissions or unintentional errors, such as the omission of a comma between key value pairs.

The configurable parser 100 is guided by an adaptable configuration that specifies the function and priority of strings of punctuation. Parsing becomes a question of choosing the right configuration and of disambiguating ambiguous punctuation. For example, there may a standard, adaptable configuration that works for most lines of a log. Structured lines with unusual separators may require addition of the separator string to the configuration.

The function and processing order of punctuation is configurable at the configurable parser 100 by loading a configuration file. An example is shown in Table 3. The section named matchConfiguration controls how the parser matches strings to functions. The section named processingConfiguration, on the other hand, controls the order of processing of the matched strings. The functions of punctuation in the log lines are to bracket items, separate a key from a value, and separate items (e.g., key values or fields in a structured list). In this example, there are at least two different types of brackets: quotes and parentheses. Quotes use the same string to begin and end the bracketing. Parentheses use one string at the beginning and a different one at the end. The quote line in Table 3 shows the power of configurability. The string with two double quotes was added to enable parsing of an unexpected use of two double quotes to bracket strings as shown at Table 2.

TABLE 2
ids timestamp=2019-01-24T15.02.20.020, ipAddress=155.56.208.68,
authenticatedSubject=““anonymous””

For example, the configurable parser's 100 standard configuration may also be based on heuristics about punctuation, the usual functions of the punctuations, and the best order to process the punctuations. In the standard configuration, the separators may be the tab, semi-colon, comma, and space. This can also be the order to split on them. The space may also be used for padding rather than separating. For example, two spaces occur in “Jan 2” but only one in “Jan 12”. Such padding can be ignored when splitting a line on separators.

The separators may separate fields in a structured list or key values in a list of key values. The structured-only separators may only be used to separate fields in a structured list. In the standard configuration, the structured-only separators are the hash and the caret. Like the other lists, this list can be extended. For example, the usual key value separators may be the colon and equals sign; the commonly occurring brackets may be the curly, square, round, and angle brackets; and the commonly occurring quotes are the single and double quote. In this example, the configured, usual order of processing is curly bracket, square bracket, rounded bracket, double-double quote, double quote, single quote, and angle bracket. As with the separators, this order is configurable by a configuration file.

TABLE 3
# Comments begin with hash# Configurable types to match, matchType
# separatorForLists changes which character is used to separate items in a
list
separatorForLists:s
matchConfiguration:
openParenthesis:{s[s(s<
closeParenthesis:}s[s)s>
quote:““s”s'
separator: s,s;s\t
structuredOnlySeparator:#s\hat{ }
keyValueSeparator:=s:
processingConfiguration:
separatorForLists:,
bracketMatchTypes:openParenthesis,closeParenthesis,quote
separatorForLists:s
bracketProcessOrder: {s[s(s““s”s's<
separatorOrder:\ts;s,s

The configurable parser 100 may also allow configuration of recognizing a list of symbolic strings such as “->” which may be used to mean from to in some logs. But this and similar symbolic strings may conflict with the use of brackets, so this symbolic string may not be part of the configurable parser's standard configuration (but as noted may be configured as an option).

The configurable parser 100 may also be configured to lookup alphabetic content (e.g., verbs or evaluative words like ‘failure’) in a dictionary of significant terms and then locate text blocks containing those terms. These text blocks may specify the meaning of an event, so focusing on the text blocks may provide quick comprehension of a line in the log being parsed.

When the configurable parser 100 is initialized, the configurable parser may generate a regular expression (which may be referred to as a regex or a classifier regex) to match and classify the punctuation configured in a match configuration file. For each line in a log, the configurable parser may find the punctuations and content, which is everything between the punctuation. The punctuations may be found using a regex that considers everything other than alphabetic characters and digits to be punctuation. An example of a regex for Python is shown in Table 4 below. The regex of Table 4 explicitly includes the underscore as a punctuation because by default †W (e.g., any word character) does not count underscores as punctuation. The configurable parser may apply the classifier regex to the punctuation to classify punctuation strings according to the configured classes, such as structured-only separator, separator, key value separator, open parenthesis, close parenthesis, quote, and/or the like. All non-matching punctuation may be classed as “other punctuation.”

TABLE 4

[ _\W ] { 1 , }

Having classified the punctuation by its function and the content by its classes (e.g., verb), the configurable parser 100 may determine (e.g., find) the hierarchical structure of the line and locate phrases containing important terms. The following describe how the hierarchical structure of a line is determined. Table 5 shows an example of an input line of text 102 from a log, and FIG. 3 depicts an example hierarchy generated from the line of text. The original line from the log seems to be missing a comma after terminal=pts/0, and it might also be missing an underscore. Does it have a key user_pid or is user at the end of the msg key? Most likely, the user is part of the msg since all the other keys are single word and none use an underscore. Adding a configuration option to consider all keys to be a single word may cause the configurable parser to interpret the msg key value as msg=audit(1509016692.646:759): user.

TABLE 5
<14>Oct 26 11:18:12 sid-erp audispd: node=sid-erp type=USER_START
msg=audit(1509016692.646:759): user pid=31605 uid=0 auid=0 ses=51
msg=‘op=PAM:session_open acct=“hdbadm” exe=“/bin/su” (hostname=?,
addr=?, terminal=pts/0 res=success)’

### Computing the Hierarchical Structure

The hierarchical structure may be considered a combination of two parts: a bracket structure and a separator-induced structure. The bracket structure corresponds to the explicit nesting of some sections of a line inside other sections. Explicit refers to nesting created by punctuation that encloses a portion of a line. The depth of nesting may go from zero (for no nesting, for example) to a maximum level corresponding to the maximum depth of nesting of the line. After computation of the bracket structure, the parser 100 may use the separators and brackets to divide the line into parts on a level-by-level basis from zero to the maximum level. In most cases, this yields a correct structure. The potential for incorrect structures does exist and can be addressed.

### Bracket Structure Computation

The bracket structure may be computed based on the punctuation commonly used to group items, but this may also be a configurable aspect of the configurable parser 100. The following describes the bracket structure computation assuming a standard configuration. The standard configuration may identify, as brackets, punctuations or other symbols, such as the curly, square, round, and angle parentheses, and the single and double quotes, e.g., { [ ( “ ” ″ ′ <, that is, curly brackets, square brackets, rounded brackets, two double-quotes, double quotes, and single quotes. This order is the standard matching order (which may be defined in the configuration file 118). The bar character (“|”) may also be used to bracket items, but is also used for other purposes such as a field separator (e.g., in the header of the CEF format) or as a connector to pipe the output of one command to the next in a sequence of commands. Due to this ambiguity, the bar character may not be considered by the configurable parser 100, when computing the bracket structure. An attempt to disambiguate the bar character may be made after computing a hierarchical structure for the line. An exception is the CEF format, which is easy to recognize, so is recognized and parsed in accordance with its specification.

Since the term bracket can refer to any punctuation used to group items, the brackets may be referred to as parentheses (e.g., { } [ ] ( ) < >). A matching pair of brackets may be considered to contain the items it encloses. Matching of brackets is done type by type, in a certain order, such as in the following order { } [ ] “ ” ( ) ″ < >. This order (which may be defined in the configuration file 118) may correspond to the reliability that the punctuation is used for grouping. For example, angle brackets are not always used to group. They may function as lesser or greater than signs, or as the ends of an arrow, as in “->”. Rounded brackets might be used as a smiley, such as “:)”. Single quotes might be used as apostrophes, as in the word “user's.” To match the brackets, the line may be abstracted to them, as in the Table 6 example of a line and its abstraction. The linear position of each bracket may be remembered. Here, the square brackets are matched rather than the angle brackets because they are processed first, which makes the angle brackets incompatible. The incompatibility is detected by the parser 100 by keeping track of the depth of nesting of each bracket in the abstraction.

TABLE 6

1.1.1.90 - - [13/Sep/2006:06:58:52 -0700 <-- start] “PROPFIND
/svn/trunk HTTP/1.1” 401 > failed
[<]“”>

Initially every bracket is at depth zero (in other words, not nested). The numbers below the abstraction show the depth. Any third line shows matching brackets as matching letters:
[<]“ ”>
000000

As brackets are matched, all the brackets inside go up in depth of nesting. For example, after matching the square brackets, the depths and matches are:
[<]“ ”>
010000
a a

The meaning of the ‘1’ below the angle bracket is that it is contained by a pair of matching brackets, in this case, the square brackets. The second angle bracket has a zero below it because it is inside no container. The two angle brackets cannot be matched because they are at different nesting depths. For brackets to match, the brackets must both be inside the same containers, but having different depths means they are not in the same containers. In this example, the quotes, however, can be matched, since they are at the same depth and are both in the top container as follows:
[<]“ ”>
010000
a abb.

All the brackets in the next example can be matched. Following the usual order, the curly brackets are matched, then the square ones are matched as follows:
({[ ]})
001100
abba.

Finally, the rounded brackets are matched as follows:
({[ ]})
012210
cabbac.

The square brackets are at depth of 2 because they are nested inside two outer containers, the curly and rounded brackets. Here is another example of adjusting depths as brackets are matched. All brackets are initially at depth zero as follows:
{(} {)}
000000.

The first set of curly brackets is matched as follows:
{(} {)}
010000
a a.

The second set of curly brackets is matched as follows:
{(} {)}
010010
a ab b.

The round brackets cannot match because, although they are at the same depth, they are in different containers. If they were in the same container, all the brackets between them would be at the same or a greater depth.

### Bracket Match Condition

As illustrated by the previous examples, the condition for brackets to match is a potential pair of brackets can only match if the pair of brackets are at the same depth and all the brackets between them are at the same or greater depth. If these conditions are fulfilled, the pair is matched and all brackets between them increase in depth because they are enclosed by the pair.

### Bracket Processing Algorithm

For each bracket type, the configurable parser 100 may process from the beginning of the line to its end, assuming an opening bracket should match the first closing bracket that follows it. This gives rise to three situations in which brackets are ignored. First, if a closing bracket is encountered but there is no opening bracket before it, the closing bracket is ignored, because there is no opening bracket to match it with. Second, if both an opening and then a closing bracket are encountered but the pair violate the bracket match condition, both brackets are ignored and marked as conflicting because they conflict with the bracket structure created by previously processed bracket types. Matching the opening bracket with another subsequent closing bracket would also violate the bracket match condition. Third, if an opening bracket is encountered but there is no closing bracket before the end of line, the opening bracket is ignored, because there is no closing bracket to match it with.

The quote characters may be processed similarly to the parentheses. However, because the opening and closing punctuation are the same character, it may not possible for the parser's algorithm to match quotes which are nested; they may always interpreted as being not nested. Interpretation (3) below is made rather than (4).

| | |
|---|---|
| “Run the program in “fast” mode” | (1) |
| ““”” | (2) |
| aabb | (3) |
| abba | (4). |

However, if inner quotes are escaped, they will be matched, as in the next example, where the first backslash-quote matches the second.

| | |
|---|---|
| “Run the program in \“fast\” mode” | (1) |
| ““”” | (2) |
| abba | (3). |

Errors in matching brackets may be recorded, and the bracket may be ignored during parsing. ML 112 may be used to detect and resolve the errors. For example, the matching errors may be used to train ML 112, which can learn to detect the possible errors. The possible errors are shown in this Python code extract as shown in Table 7.

TABLE 7

```
class bracketError(IntEnum):
  closingBeforeOpeningParenthesis = 1,
  bracketMatchConditionViolated = 2,
  noClosingParenthesis = 3,
  noClosingQuote = 4
```

### Computing the Bracket Structure in Special Cases

In the case of apostrophes and escaped quotes, the bracket structure may be determined heuristically. Other special cases may require intervention via a user interface from a user that can confirm or correct the computed bracket structure. These special cases include for example unusual brackets inside quoted keys or values, conflicting brackets, and unusual brackets in a structured line or key value line.

With respect to apostrophe, it has the same character code as a single quote but the single quote is really a single punctuation mark that can be ignored in computing the bracket structure. Table 8 shows a highlighted example of an apostrophe that is ignored. Line 1 is the log line. Line 2 is the log line abstracted to its punctuation. Line 3 uses matching letters to show which brackets match. The highlighted (in bold) punctuation mark is an apostrophe that is ignored because a heuristic rule identified it as a possessive apostrophe. There is a similar rule for negation using “n′t” as in don't.

TABLE 8

| <14>Oct 26 11:18:12 sid-erp audispd: user's_pid=5 | |
|---|---|
| msg=‘acct=“hdbadm” exe=“/bin/su”’ | (1) |
| <> :: - : '_= =‘=“” =“//”’ | (2) |
| a bb c ca | (3) |

It is a practice to escape a double quote inside a pair of double quotes by preceding it with a backslash. The JSON format prescribes this escaping mechanism. To deal with this mechanism, two successive back-slashed quotes are matched by the configurable parser 100 if they are inside a pair of double quotes. The next example shows that the escaped quotes around the timestamp and message keys and their corresponding values are matched. The i^{th} pair of quotes encloses these key values, which requires them to be escaped.

TABLE 9

| {“_type”:“syslog”,“_source”:{“@timestamp”:“2017-02- | |
|---|---|
| 16T00:33:59.889Z”,“ingestor_message”: | |
| “{\“timestamp\”:\“1487205239.009833927\”,\“message\”:\“Rou | |
| te Registrar.Executing script\”}”}} | |
| {“_”:“”,“_”:{“@”:“--::.”,“_”: “{\“\”:\“.\”,\“\”:\“ . | |
| \”}”}} | |
| ab b cc d d ef f g | g h h ij k k l l m m n |

njiea

A quoted key or value can contain any characters including unmatched brackets. Table 10 at line 2 is the correct structure, which ignores the highlighted (see bold) curly brackets inside the first key and its value, but line 3 is an incorrect structure computed using the usual order of matching brackets. This case is likely to be rare but is still handled by the configurable parser.

TABLE 10

| {“_type{“:”syslog}”,“_source”:{“@timestamp”:“2017-02- | |
|---|---|
| 16T00:33:59.889Z” }} | (1) |
| {“_{“:”}”,“_”:{“@”:“--::.” }} | |
| | (2) |

| | |
|---|---|
| ab b c c d d ef f g | g ea |

| | |
|---|---|
| {“_{“:”}”,“_”:{“@”:“--::.” }} | |
| | (3) |

| | |
|---|---|
| ab cd dcb e e fg g h | h fa |

In this case, a solution is to recognize the format as JSON and then parse it as such. If the format uses quoted keys or values, but is not JSON, an alternative strategy is to re-process the line, matching quotes first. In the next example at Table 11, this strategy results in the correct bracketing structure that ignores the highlighted (see, e.g., bold) brackets. The previous example has been made non-JSON by changing some colons to equals signs. In cases like this, the user should be asked via a user interface to resolve the conflict. Here, the user may be asked to confirm that the highlighted brackets are part of the key and value, respectively, and should be ignored.

TABLE 11

| {“_type{“=”syslog}”,“ source”={“@timestamp”=“2017-02- | |
|---|---|
| 16T00:33:59.889Z” }} | (1) |
| {“_{“=”}”,“_”={“@”=“--::.” }} | |
| | (2) |

| | |
|---|---|
| ab b c c d d ef f g | g ea |

| | |
|---|---|
| {“_{“=”}”,“_”={“@”=“--::.” }} | |
| | (3) |

| | |
|---|---|
| ab cd dcb e e fg g h | h fa |

The configurable parser's 100 algorithm for non-JSON lines is as follows. First, match brackets using the usual order of brackets. Second, if the line contains some quoted keys, then match the brackets starting with the quotes, followed by the other punctuation in the usual order. If the bracket structures computed in steps 1 and 2 are not the same, there are conflicts to be resolved, otherwise there are no conflicts. If there are conflicts, generate a user interface to enable the user to resolve the conflict(s).

If the configurable parser 100 finds conflicts in the bracketing structure as shown by the “failed” at Table 12, the user may be asked, via a user interface, to resolve them. For example, the line with the possible conflict may be presented via a user interface and each bracket in the line may include a drop-down menu that lists all the brackets it could match, including “none”. Choosing “none” indicates the bracket is excluded from a re-computation of the bracket structure. Moving to an item in the drop-down menu causes the corresponding bracket to be highlighted, so the user can see which brackets would be matched. The order of potential matches in the menu is first the computed match, if any, then “none”, and then other potential matches from nearest to most distant. After making modifications, the user may trigger via a user interface re-computation of the bracket structure. When the bracket structure is correct, the user may accept, via a user interface, the bracket structure.

TABLE 12

1.1.1.90 - - [13/Sep/2006:06:58:52 -0700 <-- start]
“PROPFIND /svn/trunk HTTP/1.1” 401 > failed
[<]“”>
010000
a abb

After a bracket is set to “none,” the bracket is removed from the menus of all brackets, except for the menu of its mate, if any. There it may be greyed out to show that it was the mate before the user set it to none. As an option the user might interact with the abstraction. Being shorter than the line, it may be quicker to work with. At the same time, the interaction would be shown in the representation of the line. To make it easier to read, the line representation might show the containment hierarchy induced by the last computed bracket structure. As described, the user controls when the parser recomputes the bracket structure. If, for example, the user wanted the parser to match the angle brackets, it would be sufficient to set one of the square brackets to “none”, enter “recompute”, then “accept”. From the user interaction, the configurable parser can learn that a more correct configuration for this line is one without the angle bracket as a bracket. In addition to resolving conflicts, the user may also add matching bars to the bracketing structure before the computation of the separator-induced structured. Other less usual brackets may also be added. After the punctuation has been classified and before the line hierarchy is computed, the user may modify the function of the recognized punctuation to control whether brackets are ignored and whether punctuation is internal or not. Internal punctuation may be ignored, when computing the hierarchy.

After computing the bracket structure (which divides the line into levels), the configurable parser 100 may use the separators and brackets to split the line into parts level by level from level zero to the maximum level of the line. The initial part is the entire line. The parsing process creates a hierarchical representation of the line and its parts, its key values, empty key values and leaf parts, as shown at FIG. 3. For example, the configurable parser 100 may disambiguate ambiguous punctuation, filtering out punctuation to be ignored. Next, the configurable parser may decide which separator to use and split the part into sub-parts using it. The choice of separator is based on the priority order set in the configuration file 118 (see, e.g., Table 3 at separatorOrder). If there are no separators, the configurable parser may split the part into sub-parts on brackets. The configurable parser may then determine the type of each new sub-part and process it accordingly.

As noted, some punctuations can be ambiguous. This may be handled by a filtering function as noted above. A punctuation can be ambiguous when, depending on its context, it is either internal to an item or external to it. For example, a comma used to separate items in a list is external, whereas a comma inside a URL or path is internal. Colons have multiple uses that need to be disambiguated. Not only are they used as separators between a key and value, they are also widely used as value-internal punctuation, such as in MAC addresses. An SQL statement can also include standard separators. To avoid splitting them, they can be recognized by the parser 100, so their punctuation can be marked as internal. A decision is whether ambiguous punctuation is internal or not.

To make this ambiguity decision, the parser 100 may include a punctuation filtering function. This punctuation filtering function detects items that potentially contain ambiguous punctuation. Examples are URLs and paths (which can contain commas, semi-colons, colons, equals signs, rounded brackets, and square brackets). As lines are processed level-by-level through the hierarchy (see, e.g., FIG. 3), the punctuation-filtering function finds the beginning and ending of items that contain ambiguous punctuation and marks their punctuation as internal before division into parts.

When deciding which separator to use next, the configurable parser 100 may first decide which of two cases are true of the current part. Case 1 is a line consisting of fields separated by a non-standard field separator. The field is a data element in the line marked off by the field separators. The field can be complex, that is, contain data elements itself. Case 2 is all other cases and is the most common and standard case. An example of case 1 is shown at Table 13. This line fits case 1 because the field separator is a hash character, not one of the standard separators defined in the current configuration 118 (see, e.g., Table 3). The first field is a complex field, a header with space-separated fields of its own, but this makes no difference to the decision that the line fits case 1.

TABLE 13

Jan 3 13:45:37 192.168.5.1 #2.0##2010 01 08
14:30:36:084#+6:30#INFO#com.sap.mycomponent#20#System
[28]#Server {0} will be down in {1}
minutes!#2#MyServer#15#

In case 1, the configurable parser 100 may divide the line into parts (e.g., fields) at the hashes, and may add each field as a child to the top part. Any fields that contain separators are complex and are added to a queue for a next round of processing. Any escaped field separators may be ignored when dividing the line into fields. A backslash in front of a character may be a way to escape it. There are several options to detect case 1. For example, non-standard separator is listed in the configuration, user specifies the separator, heuristics, and machine learning.

### Case 1: Heuristics for Detection of Non-Standard Field Separator

Potential non-standard field separators are the characters in the “other punctuation” plus the structured-only separators. The following characters (which are unlikely to be field separators) may be excluded: brackets, quotes, colons, equals-signs, periods, dashes, underscores. Heuristics consider the statistical properties of these potential separators. Examples of which include: how many times the character occurs; the range of the character computed as its last offset in the line minus its first offset, divided by the line length; the number of times the character occurs in a group of two or more, e.g., ‘##’ (empty fields); the number of times the character occurs around matching brackets as in this extract: #“failure, file not found”# (which may be a strong sign that the hash is a separator). One heuristic to choose a separator is to assign each potential separator a score that is a weighted sum of its properties. The highest scoring one wins. Scoring considers both the standard and potential non-standard separators. Note also that it considers only the separators in the current part at the current bracket level.

### Case 1: Non-Standard Field Separator, Machine Learning

ML 112 may be used to recognize a field separator. For example, machine learning may learn the weights for the heuristic noted above. Alternatively, ML 112 may be used to classify a line or line part by its field separator. The first approach of learning the weights may be limited to single character separators as the heuristic only considers single characters to avoid the combinatorial explosion of character combinations. Trailing whitespace may be ignored by reducing single character separators ending with a whitespace to the single character. Regarding ML 112 classification of a line or line part by its field separator, it may not allow multi-character separator strings. The training set may be extended by taking real structured lines and line parts and generating newly labeled samples by replacing the separators with others. The labels for these inputs are the replacement separator string. The training set may include some non-structured lines or parts labelled with a special value that means not structured.

If there are no structured only separators in a part, the next separator to break on is decided by their order in the processing configuration dictionary (which may be defined in a configuration file as noted above at Table 3).

When a part is split by the parser 100, the separator is considered to belong to the child in front of the separator. Table 14 shows an example of splitting at semi-colons at indices i, j and k. Since the last semicolon belongs to ‘z;’, there are only 3 parts. The last part is therefore omitted. That it is a spurious part is detected because it is the last part and its start and end are the same, k+1=e.

TABLE 14

| x;y;z; | | | |
|---|---|---|---|
| si j ke | | | |
| s | i+1 | j+1 | k+1 |

| | |
|---|---|
| i+1 j+1 | k+1 e |

When there are no separators to split a part, it is split by the parser 100 on any bracket pairs that are marked “use.” Several examples show how this works. Table 15 depicts an example part with no separators, but two bracket pairs marked “′use.” The “s” and “e” are the start and end of the part.

TABLE 15

X[a, b]Y[c,d]Z
si j m ne

Splitting at the two bracket pairs results in parts with the following start and end indices as shown at Table 16.

TABLE 16

| | | | |
|---|---|---|---|
| s | i | j+1 m | n+1 |

| | | |
|---|---|---|
| i | j+1 m | n+1 e |

Parts X, Y and Z are processed by the configurable parser 100 like any other part that is typed as single key value or as field and processed accordingly. The bracketed parts are slightly different. They result in parts of type bracketed with a child part that is added to the nextRound queue. The child's level is one more than the parent's level. As an example, part (i, j+1) becomes a bracketed child of the current part with its own child (i+1, j+1). This child is added to the nextRound queue. In some cases, there might not be any content between brackets, as in the next example at Table 17.

TABLE 17

[a, b][c,d]
i jm ne

Calculating the pairs using the same algorithm as used for the previous case yields the same pairs as shown in Table 18. But some pairs have the same start and end. Such pairs occur because of lack of content and are dropped. Here there is: s=i, j+1=m, and n+1=e, which leaves only the two pairs: (i, j+1), (m, n+1). These remaining two pairs are processed like the previous example part (i,j+1).

TABLE 18

| | | | |
|---|---|---|---|
| s | i | j+1 m | n+1 |

| | | |
|---|---|---|
| i | j+1 m | n+1 e |

As parts are split by the configurable parser 100, the type of each sub-part is determined and it is processed accordingly. There are four types: field, key value, empty-key value, and leaf. Fields contain separators and may require further processing so are added to the processing queue. Key values may be processed to record the key and the key value separator. The key and key value separator may also inherit a parent key name from their parent part. The key's full name is the concatenation of its parent's name and its own name, for example. The configurable parser 100 may create a new sub-part for the value of the key and its parent key is set to the full key name. Then the value sub-part is added to the processing queue. Empty key values may be processed like key values except that they have no value part. Leaves are parts that are not processed further. What counts as a leaf is configurable. In the standard configuration, a part that is bracketed but contains no separators itself is a leaf. Parts which match one of a set of known syntactic types are also leaves. Examples of syntactic types are IP addresses, URLs and paths.

The configurable parser 100 may recognize a part as a key value if it contains a key value separator and the text in front of the separator is a plausible key. Any quoted key and anything that does not match an anti-key pattern is plausible. An example of an anti-key pattern is a string that begins with a digit. This broad definition of plausibility is adopted because of the range of key types. Although many keys are technical words (e.g., restricted to alphabetics and underscores), some keys contain special characters such as “@” or brackets. Keys may also be quoted, and contain anything inside the quotes, even other quotes, if they are escaped with a backslash. Keys may also consist of multiple words separated by whitespace.

The configurable parser 100 may operate on a commonly used format, which is a list of key values, which might be preceded by a whitespace-separated header. Three examples are given below at Table 19. In processing these formats, the first operation is to divide the lines at the key value list separator, in this case the comma. If the first part, in bold, contains spaces and the second part is a key value, the first part is special-cased because a decision is needed about its form. Which of the following three forms (which corresponds to the preceding examples) does it have: only a header, a header followed by a key value, or only a key value. The attributes of the already discovered key values in the list can be used to decide which of the three cases is present. The attributes of use are: the key value separator; the type of key (e.g., quoted, single-word, multi-word, alphabetic only, etc.); and/or the type of value (e.g., quoted, containing whitespaces or single-valued, meaning without whitespaces).

TABLE 19

2019-01-22T12.21.13.013 umtrace, ipAddress=205.10.88.29,
severity=INFO, crtAccount=ids
2019-01-22T12.21.13.013 umtrace ipAddress=205.10.88.29,
severity=INFO, crtAccount=ids
timestamp = 2019-01-22T12.21.13.013, place=umtrace,
ipAddress=205.10.88.29, severity=INFO, crtAccount=ids

For example, having observed that formats are not always consistent, only the key value separator (e.g., “=”) may be used as input to the parser's algorithm to decide the form of part one. This can also be made configurable. Another complicating factor is that the colon can be used both as a key value separator and as internal punctuation in syntactic types like MAC addresses. So, if the second part uses the colon, a filter may be executed on the first part to mark the punctuation of these syntactic types to be internal. The equals sign often occurs in URLs or paths, but these are filtered out by a prior filtering step that finds URLs and paths to mark their punctuation as internal. Having filtered out key value separators that are internal, it is assumed that the last key value separator must be the correct one, if part one contains a key value. Starting from it, a backward search for the key is conducted. If a quoted key is found, it is accepted without looking inside it; otherwise, the potential key is only accepted if it is plausible as a key. A key value part is created and its value part, if any, is added to the next processing round. If no key value is found, there is only a header, which is added to the next round. If a key value is found, but there is nothing in front of it, the key value part replaces the first part, otherwise it is inserted after the first part.

After lines are fully parsed, the parsed lines may be grouped in various ways. Lines might first be grouped by the top-level format of the body. For example, the grouping may be based on: structure (e.g., a sequence of fields separated by a fixed separator string); key value (e.g., a sequence of key value pairs, with each pair separated by a fixed separator string, key value can be thought of as structured with fields that each contain a key value pair); free-text (e.g., text, usually with embedded fields and/or embedded key value pairs); and/or a known format (e.g., JSON, CEF, or syslog). An additional criterion for division into groups is the presence or absence of a whitespace-separated header in front of the body. An example of a line with no header is line 3 of Table 19. The other two lines have whitespace-separated headers. Another option is to group lines according to the more abstract formats: structured, with keys, without keys, or recognized format like JSON or CEF. These last two also fall into the class of lines with keys but would form separate groups.

Within format groups, the lines with the same features can be grouped together by the configurable parser 100. Features are derived from the parsed line and can include things such as keys, empty keys, recognized verbs or words, and syntactic types of leaves (e.g., IP address or integer type). Features may also be punctuation like separators and matched or unmatched brackets. Lines with keys can be grouped by that feature alone, putting lines with the same keys in the same group. If the keys of different groups overlap substantially, these groups can be gathered by the configurable parser 100 into a containing group. If a group with the same keys differs in its verbs and/or empty keys that group can be subdivided into sub-groups that have the same sets of verbs and empty-key features.

For more fine-grained grouping, the sequence of features of a line can be used. Lines with the same sequence of features belong to the same group. For example, the two lines in Table 20 have the same sequence of features shown in Table 21. Features in bold are recognized words. All other features are keys and empty keys. These groups may then be aggregated according to keys and empty keys. Keys might have different orders so key comparisons can be done unordered. Verbs and words, on the other hand, tend to be ordered so should be compared as a sequence. Empty keys within a series of keys may be compared unordered, but otherwise should be compared ordered.

TABLE 20

<14>Oct 26 11:18:12 sid-erp audispd: node=sid-erp
type=USER_START msg=audit(1509016692.646:759): user
pid=31605 uid=0 auid=0 ses=51 msg=‘op=PAM:session_open
acct=“hdbadm” exe=“/bin/su” (hostname=?, addr=?,
terminal=pts/0 res=success)’
<14>Nov 27 13:20:10 sss audispd: node=sss type=USER_START
msg=audit(1509016692.646:759): user pid=4 uid=1 auid=1
ses=1 msg=‘op=PAM:session_open acct=“adm” exe=“/bin/su”
(hostname=?, addr=?, terminal=pts/1 res=success)’

TABLE 21

audispd: node= type= USER_{—}START msg= user pid= uid= auid=
ses= msg= op= PAM: session_{—}open acct= exe= hostname=
addr= terminal= res= success

There are two options for computing and comparing keys: use simple key names or use hierarchical key names. In Table 21, simple key names are used. Hierarchical key names are created by prepending the parent key name to the key's simple name. For example, the hierarchical name for the key acct=is msg=\hat{ }acct=, using the caret to concatenate them. As per the example keys, the key value separator is considered part of the key.

A header may begin a line, but a header may also occur in sub-parts of lines, such as when a field or a key's value contains a log line with a header. The parser 100 may group by features. When this is the case, the grouping may be used to answer questions about headers such as which categories of header are present, which different types within each category are present, which headers are unknown, and which lines begin with the same type of header. Lines which begin with the same type of header are probably from the same type of log producer, so logs from the same producer type may be grouped together.

Regarding lines having the same body but different headers, these lines are probably from the same type of producer but either transited a log forwarder that added information or came from configurable log producers that were differently configured. A more difficult task is to recognize when a line that can occur by itself is contained in another line. This can occur if the initial line is routed through a forwarder that adds a header to it or packs it into a field or key value. The forwarded line would contain the sequence of features of the initial line, making it possible to recognize this situation.

Headers may also fall into a small number of categories that are distinguished by their format. Examples of these categories include whitespace-separated header; syslog header, a type of whitespace-separated header; key value, which might have a header portion; JSON, a type of key value log that might have a header portion; CEF, which has a header separated by the bar character (|); and multiple headers (e.g., a syslog header followed by a CEF header). In contrast to the header category, the header type depends on the content of the header and can be computed from features. Which features to use depends on the high-level category of the header. CEF is the simplest format to group into header types because it has fields that identify the producer of the line and the producer's version. Lines can be grouped by producer and then sub-divided by version. CEF also has a field to identify the event, so lines may be further subdivided by the content of that field. Whitespace-separated headers can be divided into groups that share a beginning sequence of syntactic types. This grouping decision can take account of alternative syntactic types like hostname and IP address. Some lines might use one to identify a host, some the other. Alternative syntactic types can be considered to match. Key value formats might or might not have headers. Lines with the same keys in the same order at the beginning but with differing keys afterwards have a kind of header-body structure, possibly indicating that logs with the same initial keys are from the same log producer.

Two types of synergies between the parser and machine learning are distinguished by their goals: improve the parser through supervised machine learning and perform log-processing tasks using supervised machine learning. Both goals depend on converting the output of the parser into labelled data for use in supervised machine learning. The idea behind the second goal is that for many problems machine learning could be much faster than a solution based on completely parsing lines into components. Some ideas for achieving the two goals are given in the next two sections.

Assuming the parser has been configured to correctly parse a collection of lines it has learned things such as which parser configuration works, which ambiguous punctuation is internal, which is external, which brackets create the bracket hierarchy, which single quotes are apostrophes, which syntactic types occur where in a line, which lines or line parts are structured with which separator, which keys occur where in the line using which separator between the key and value and/or errors (e.g., missing commas or stray brackets).

Missing commas can be found automatically via machine learning 112, but stray brackets may require confirmation from the user that they should be ignored. An example of a line with stray double quotes is shown in Table 22. It has 13 double quotes, which it seems impossible to match up. Yet some elements do need to be quoted to group them (e.g., “Mozilla/5.0 (Windows NT 10.0; WOW64; Trident/7.0; Touch; rv:11.0) like Gecko”), which is an HTTP User-Agent string. Learning to ignore all the other quotes would seem to lead to the best parsing results.

TABLE 22

<181>2018-10-01T13:35:05.123456Z apache: “GET: 10.0.0.0 -
I0 [23/Oct/2018:16:17:15 +0800] “GET “co.cloud.com “
“/co/notification/default/N ” ”” HTTP/1.1” 200 773
“https://co.cloud.com/shells/launch.html?client=001&langua
ge=EN” “Mozilla/5.0 (Windows NT 10.0; WOW64; Trident/7.0;
Touch; rv:11.0) like Gecko”

Learned information can be used as labels for training samples. For example, a machine learning classifier may be trained from lines labeled with the correct configuration. Given a line, the classifier's output may be the configuration for parsing the line correctly. Although, there is a standard configuration that correctly parses most lines, there are lines that may be more correctly parsed using a custom configuration at the parser 100. A trained ML 112 learning classifier can also identify the syntactic types of parts. As the parser divides a line into parts, the parser may recognize a part's syntactic type using the ML 112 classifier trained on labeled part types from parsed lines.

ML 112 may learn to identify a structured separator and then detect the structured separator. Given a line, the machine learning classifier may output the separator for the line if its top level is structured. A special value may indicate not structured. The classifier may be applied part by part to the line to identify separators for fields or key values that are structured.

Some of the learned information may correspond to labels on parts of a line, so a machine learning classifier trained on the parts of a line may output the line part (e.g., its start and end index, as well as a label). This is, in effect, named entity recognition (NER) with the labels as the entity types. NER for syntactic types with ambiguous punctuation, such as URLs, may replace the configurable parser's disambiguation code and make parsing more accurate. The NER may be extended to identify missing items like commas. The start and end index would be the same and would point to the place just before the missing item. Adding missing items before parsing would result in a more accurate structure of the line.

Aside from enabling configurable parser improvements, the facts learned from parsing may be used to train independent named entity recognizers. This is most useful for syntactic types like URLs that can be very complex, so are difficult to recognize by a simple regular expression. Learning from parsing may also enable ML 112 to cluster lines to their event type; cluster related event types (e.g., events from the same producer); detect event types that have never been seen before; and detect defects in a line (e.g., mis-matched brackets or missing separators). Solutions for these tasks may enable the following overlapping use cases: get a quick overview of a log file by compressing its contents to event types and related types; find events relevant to a purpose; and/or evaluate if open source or third-party software logs the events required for a specific purpose. Support for these use cases may facilitate the processing of log files to improve, for example, security monitoring, performance monitoring, and auditing of conformance to legal requirements.

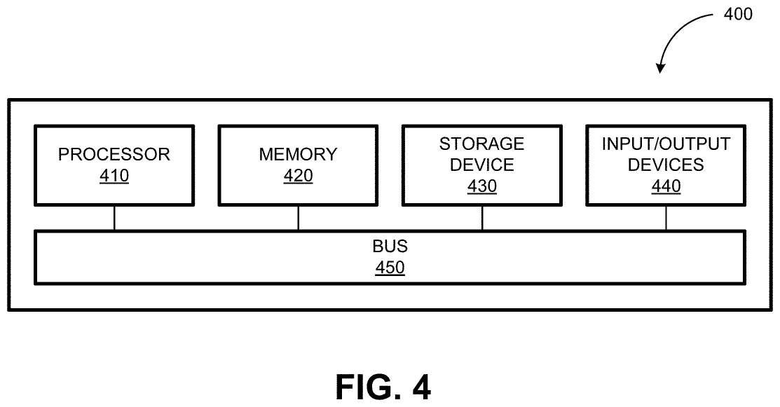

FIG. 4 depicts a block diagram illustrating a computing system 400 consistent with implementations of the current subject matter. The computing system 400 can be used to implement the user equipment or one or more of the components therein such as the screen share service 405, a screenshot engine configured to take screenshots of the display of the user equipment, and/or other components disclosed herein. As shown in FIG. 4, the computing system 400 can include a processor 410, a memory 420, a storage device 430, and input/output device 440. The processor 410, the memory 420, the storage device 430, and the input/output device 440 can be interconnected via a system bus 450. The processor 410 is capable of processing instructions for execution within the computing system 400. Such executed instructions can implement one or more components of, for example, the screen share service 405. In some example embodiments, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, a tape device, a solid-state device, and/or any other suitable persistent storage mechanisms. The input/output device 440 provides input/output operations for the computing system 400. In some example embodiments, the input/output device 440 includes a keyboard and/or pointing device. In various implementations, the input/output device 440 includes a display unit for displaying graphical user interfaces. According to some example embodiments, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet, the cellular network, and/or the like).

In some example embodiments, the computing system 400 can be used to execute various interactive computer software applications that can be used for organization, analysis, and/or storage of data in various formats. Alternatively, the computing system 400 can be used to execute any type of software applications. These applications can be used to perform various functionalities, such as planning functionalities (e.g., generating, managing, editing of spreadsheet documents, word processing documents, and/or any other objects, etc.), computing functionalities, communications functionalities, etc. The applications can include various add-in functionalities (e.g., SAP Co-Pilot, SAP Integrated Business Planning as an add-in for a spreadsheet and/or other type of program) or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A parser comprising:
at least one data processor; and
at least one memory storing instructions which, when executed by the at least one data processor, result in operations comprising:
receiving a line of text to be parsed;
processing, based on a configuration file for the parser, the line of text into parsed text by at least:
detecting one or more brackets and one or more separators in the text, wherein a first type of the one or more brackets being detected is defined in the configuration file, and a second type of the one or more separators is defined by the configuration file,
determining a hierarchy for the text based on one or more parts, the one or more parts determined from the detected one or more brackets and the detected one or more separators, and
parsing, based on the hierarchy, the text to form the parsed text; and
generating, based on the parsing using the determined hierarchy, a user interface view including the hierarchy and the parsed text.

2. (canceled)

3. The parser of claim 1 further comprising:
storing the parsed text to a database logging a plurality of text parsed by the parser.

4. The parser of claim 1, wherein at least one of the separators to be detected is a key value separator, wherein the key value separator separates at least one key and a value, and wherein the key value separator is defined by the configuration file.

5. The parser of claim 4, wherein the parser includes a machine learning module which when executed detects the pair of brackets, the key value separator, and the at least one key.

6. The parser of claim 1, wherein the detecting includes detecting one or more pairs of brackets by processing the received text from left to right and ignoring a bracket if it does not include a matching bracket.

7. The parser of claim 6, wherein a level is assigned to each of the detected pairs of brackets, the assigned level used to determine a hierarchy.

8. A method comprising:
receiving a line of text to be parsed;
processing, based on a configuration file for the parser, the line of text into parsed text by at least:
detecting one or more brackets and one or more separators in the text,
wherein a first type of the one or more brackets being detected is defined in the configuration file, and a second type of the one or more separators is defined by the configuration file,
determining a hierarchy for the text based on one or more parts, the one or more parts determined from the detected one or more brackets and the detected one or more separators, and
parsing, based on the hierarchy, the text to form the parsed text; and
generating, based on the parsing using the determined hierarchy, a user interface view including the hierarchy and the parsed text.

9. (canceled)

10. The method of claim 8, further comprising:
storing the parsed text to a database logging a plurality of text parsed by the parser.

11. The method of claim 8, wherein at least one of the separators to be detected is a key value separator, wherein the key value separator separates at least one key and a value, and wherein the key value separator is defined by the configuration file.

12. The method of claim 11, wherein the parser includes a machine learning module which when executed detects the pair of brackets, the key value separator, and the at least one key.

13. The method of claim 8, wherein the detecting includes detecting one or more pairs of brackets by processing the received text from left to right and ignoring a bracket if it does not include a matching bracket.

14. The method of claim 13, wherein a level is assigned to each of the detected pairs of brackets, the assigned level used to determine a hierarchy.

15. A non-transitory computer-readable storage medium including program code which when executed by at least one data processor causes in operations comprising:
receiving a line of text to be parsed;
processing, based on a configuration file for the parser, the line of text into parsed text by at least:
detecting one or more brackets and one or more separators in the text wherein a first type of the one or more brackets being detected is defined in the configuration file, and a second type of the one or more separators is defined by the configuration file,
determining a hierarchy for the text based on one or more parts, the one or more parts determined from the detected one or more brackets and the detected one or more separators, and
parsing, based on the hierarchy, the text to form the parsed text; and
generating, based on the parsing using the determined hierarchy, a user interface view including the hierarchy and the parsed text.

16. (canceled)

17. The non-transitory computer-readable storage medium of claim 15 further comprising:
storing the parsed text to a database logging a plurality of text parsed by the parser.

18. The non-transitory computer-readable storage medium of claim 15, wherein at least one of the separators to be detected is a key value separator, wherein the key value separator separates at least one key and a value, and wherein the key value separator is defined by the configuration file.

19. The non-transitory computer-readable storage medium of claim 18, wherein the parser includes a machine learning module which when executed detects the pair of brackets, the key value separator, and the at least one key.

20. The non-transitory computer-readable storage medium of claim 15, wherein the detecting includes detecting one or more pairs of brackets by processing the received text from left to right and ignoring a bracket if it does not include a matching bracket.
